(19) United States
(12) Patent Application Publication
(10) Pub. No.: US 2016/0128048 A1
(43) Pub. Date: May 5, 2016

(54) CONTROL CHANNEL ON PLCP SERVICE DATA UNIT (PSDU) TONES

(71) Applicant: QUALCOMM Incorporated, San Diego, CA (US)

(72) Inventors: Bin TIAN, San Diego, CA (US); Simone MERLIN, San Diego, CA (US); George CHERIAN, San Diego, CA (US); Gwendolyn Denise BARRIAC, Encinitas, CA (US)

(21) Appl. No.: 14/924,105

(22) Filed: Oct. 27, 2015

Related U.S. Application Data
(60) Provisional application No. 62/072,258, filed on Oct. 29, 2014.

(51) Int. Cl. H04W 72/04; H04L 27/26

(52) U.S. Cl. CPC H04W 72/0406; H04L 27/2602

(57) ABSTRACT

Certain aspects of the present disclosure provide methods and apparatus for communicating control information in a physical layer convergence protocol (PLCP) service data unit (PSDU) on one or more tones of the PSDU that are not used for transmitting data (or pilot signals). One example method for wireless communications generally includes generating a packet comprising a PSDU having control information conveyed in one or more tones of the PSDU that are not used for transmitting data, processing the packet to generate a signal, and transmitting the signal.

### CLAIM OF PRIORITY UNDER 35 U.S.C. §119

The present application claims benefit of U.S. Provisional Patent Application Ser. No. 62/072,258, entitled “CONTROL CHANNEL ON PLCP SERVICE DATA UNIT (PSDU) TONES” and filed Oct. 29, 2014, which is assigned to the assignee of the present application and is hereby expressly incorporated by reference herein in its entirety.

### BACKGROUND

1. Field of the Disclosure

Certain aspects of the present disclosure generally relate to wireless communications and, more particularly, to communicating control information in a physical layer convergence protocol (PLCP) service data unit (PSDU) on one or more tones of the PSDU that are not used for transmitting pilot signals or data.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address a desire for higher and higher throughput, various schemes are being developed. One such scheme is the HEW (High Efficiency WiFi or High Efficiency WLAN) being developed by the Institute of Electrical and Electronics Engineers (IEEE) 802.11ax task force. The goal of this scheme is to achieve a throughput 4× that of IEEE 802.11ac.

### SUMMARY

Certain aspects of the present disclosure generally relate to utilizing unused tones in a physical layer convergence protocol (PLCP) service data unit (PSDU) to convey control information. As used herein, the term “unused tones” generally refers to tones that are not used for transmitting data or pilot signals.

Certain aspects of the present disclosure provide a method for wireless communications. The method generally includes generating a packet comprising a PSDU having control information conveyed in one or more tones of the PSDU that are not used for transmitting data (or pilot signals), processing the packet to generate a signal, and transmitting the signal.

Certain aspects of the present disclosure provide an apparatus for wireless communications. The apparatus generally includes a processing system and a transmitter. The processing system is typically configured to generate a packet comprising a PSDU having control information conveyed in one or more tones of the PSDU that are not used for transmitting data (or pilot signals) and to process the packet to generate a signal. The transmitter is typically coupled to the processing system and configured to transmit the signal.

Certain aspects of the present disclosure provide an apparatus for wireless communications. The apparatus generally includes means for generating a packet comprising a PSDU having control information conveyed in one or more tones of the PSDU that are not used for transmitting data (or pilot signals), means for processing the packet to generate a signal, and means for transmitting the signal.

Certain aspects of the present disclosure provide a non-transitory computer-readable medium for wireless communications. The medium has instructions stored thereon, which are executable (by an apparatus, such as a computer processor) to generate a packet comprising a PSDU having control information conveyed in one or more tones of the PSDU that are not used for transmitting data (or pilot signals), to process the packet to generate a signal, and to transmit the signal.

Certain aspects of the present disclosure provide a wireless node. The wireless node generally includes a processing system, a transmitter, and at least one antenna. The processing system is typically configured to generate a packet comprising a PSDU having control information conveyed in one or more tones of the PSDU that are not used for transmitting data (or pilot signals) and to process the packet to generate a signal. The transmitter is typically coupled to the processing system and configured to transmit the signal via the at least one antenna.

Certain aspects of the present disclosure provide a method for wireless communications. The method generally includes receiving a signal and processing the signal to generate a packet comprising a PSDU having control information conveyed in one or more tones of the PSDU that are not used for transmitting data (or pilot signals).

Certain aspects of the present disclosure provide an apparatus for wireless communications. The apparatus generally includes a receiver and a processing system. The receiver is typically configured to receive a signal. The processing system is typically coupled to the receiver and configured to process the signal to generate a packet comprising a PSDU having control information conveyed in one or more tones of the PSDU that are not used for transmitting data (or pilot signals).

Certain aspects of the present disclosure provide an apparatus for wireless communications. The apparatus generally includes means for receiving a signal and means for processing the signal to generate a packet comprising a PSDU having control information conveyed in one or more tones of the PSDU that are not used for transmitting data (or pilot signals).

Certain aspects of the present disclosure provide a non-transitory computer-readable medium for wireless communications. The medium has instructions stored thereon, which are executable (by an apparatus, such as a processing system) to receive a signal and to process the signal to generate a packet comprising a PSDU having control information conveyed in one or more tones of the PSDU that are not used for transmitting data (or pilot signals).

Certain aspects of the present disclosure provide a wireless node. The wireless node generally includes a processing system, a receiver, and at least one antenna. The receiver is typically configured to receive a signal via the at least one antenna. The processing system is typically coupled to the receiver and configured to process the signal to generate a packet comprising a PSDU having control information conveyed in one or more tones of the PSDU that are not used for transmitting data (or pilot signals).

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communications network, in accordance with certain aspects of the present disclosure.

FIG. 2 is a block diagram of an example access point and user terminals, in accordance with certain aspects of the present disclosure.

FIG. 3 is a block diagram of an example wireless device, in accordance with certain aspects of the present disclosure.

FIG. 4 illustrates an example packet structure in which a PLCP service data unit (PSDU) has tones unused for conveying data, in accordance with certain aspects of the present disclosure.

FIG. 5 illustrates an example packet structure in which the position of the control information in the PSDU conveys a particular meaning, in accordance with certain aspects of the present disclosure.

FIG. 6 illustrates an example packet structure in which the control information in the PSDU has a header field associated therewith, in accordance with certain aspects of the present disclosure.

FIG. 7 is a flow diagram of example operations for transmitting a packet including a PSDU having control information conveyed on unused tones, in accordance with certain aspects of the present disclosure.

FIG. 7A illustrates example means capable of performing the operations shown in FIG. 7.

FIG. 8 is a flow diagram of example operations for receiving a packet including a PSDU having control information conveyed on unused tones, in accordance with certain aspects of the present disclosure.

FIG. 8A illustrates example means capable of performing the operations shown in FIG. 8.

### DETAILED DESCRIPTION

Certain aspects of the present disclosure provide techniques and apparatus for communicating control information in a physical layer convergence protocol (PLCP) service data unit (PSDU) on one or more tones of the PSDU that are not used for transmitting data or pilot signals.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The acronyms listed below may be used herein, consistent with commonly recognized usages in the field of wireless communications. Other acronyms may also be used herein, and if not defined in the list below, are defined where first appearing herein.
ACK . . . Acknowledgement
A-MPDU . . . Aggregated MAC Protocol Data Unit
AP . . . Access Point
BA . . . Block Ack
BAR . . . Block Ack Request
CRC . . . Cyclic Redundancy Check
DCF . . . Distributed Coordination Function
DIFS . . . DCF Interframe Space
EOF . . . End of Frame
EIFS . . . Extended Interframe Space
FCS . . . Frame Check Sequence
ID . . . Identifier
IEEE . . . Institute of Electrical and Electronic Engineers
LTF . . . Long Training Field
MAC . . . Media Access Control
MSB . . . Most Significant Bit
MIMO . . . Multiple Input Multiple Output
MPDU . . . MAC Protocol Data Unit
MU . . . Multi-User
MU-MIMO . . . Multi-User Multiple Input Multiple Output
NDP . . . Null Data Packet
OFDM . . . Orthogonal Frequency Division Multiplexing
OFDMA . . . Orthogonal Frequency Division Multiple Access
PHY . . . Physical Layer
PLCP . . . Physical Layer Convergence Protocol
PPDU . . . PLCP Protocol Data Unit
PSDU . . . PLCP Service Data Unit
QoS . . . Quality of Service
RDG . . . Reverse Direction Grant
SDMA . . . Spatial-Division Multiple Access
SIFS . . . Short Interframe Space
SIG . . . Signal
STA . . . Station
STBC . . . Space-Time Block Coding
STF . . . Short Training Field
SU . . . Single User
. . . TCP Transmission Control Protocol
VHT . . . Very High Throughput
WLAN . . . Wireless Local Area Network
   An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such a wireless node may provide, for example, connectivity for or to a network (e.g., a wide area network such as the Internet or a cellular network) via a wired or wireless communication link.

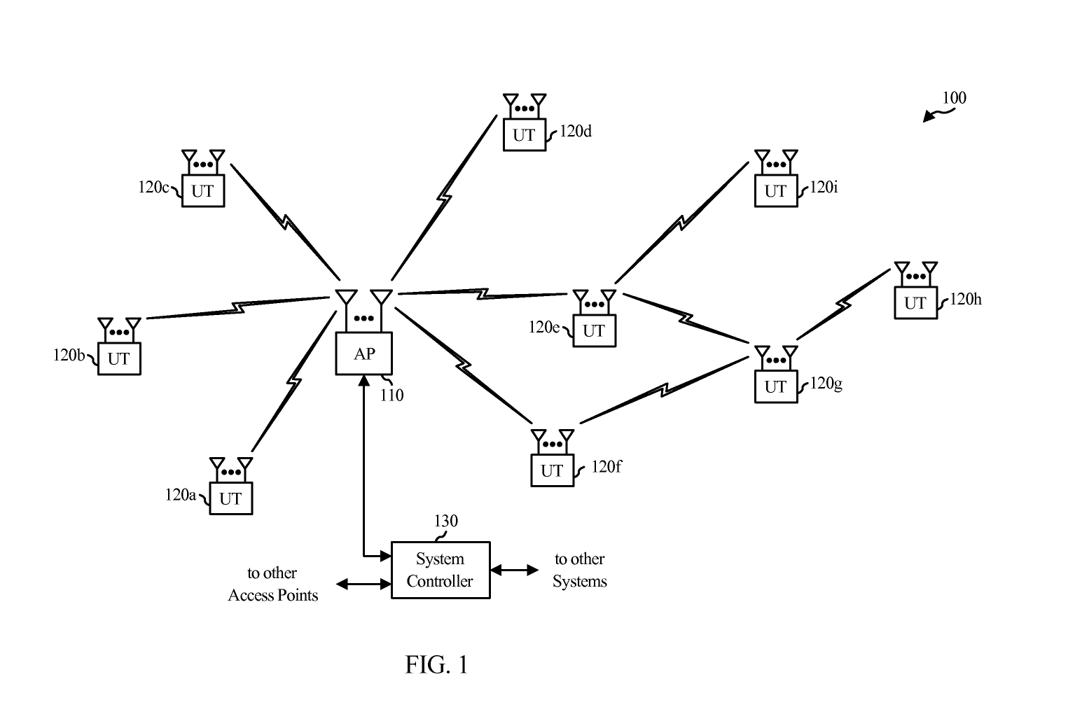

FIG. 1 illustrates a multiple-access multiple-input multiple-output (MIMO) system 100 with access points and user terminals. For simplicity, only one access point (AP) 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to a different user terminal 120.

The access point 110 and/or user terminal 120 may generate or receive a packet comprising a physical layer convergence protocol (PLCP) service data unit (PSDU) having control information conveyed in one or more tones of the PSDU that are not used for transmitting pilot signals or data, as described below.

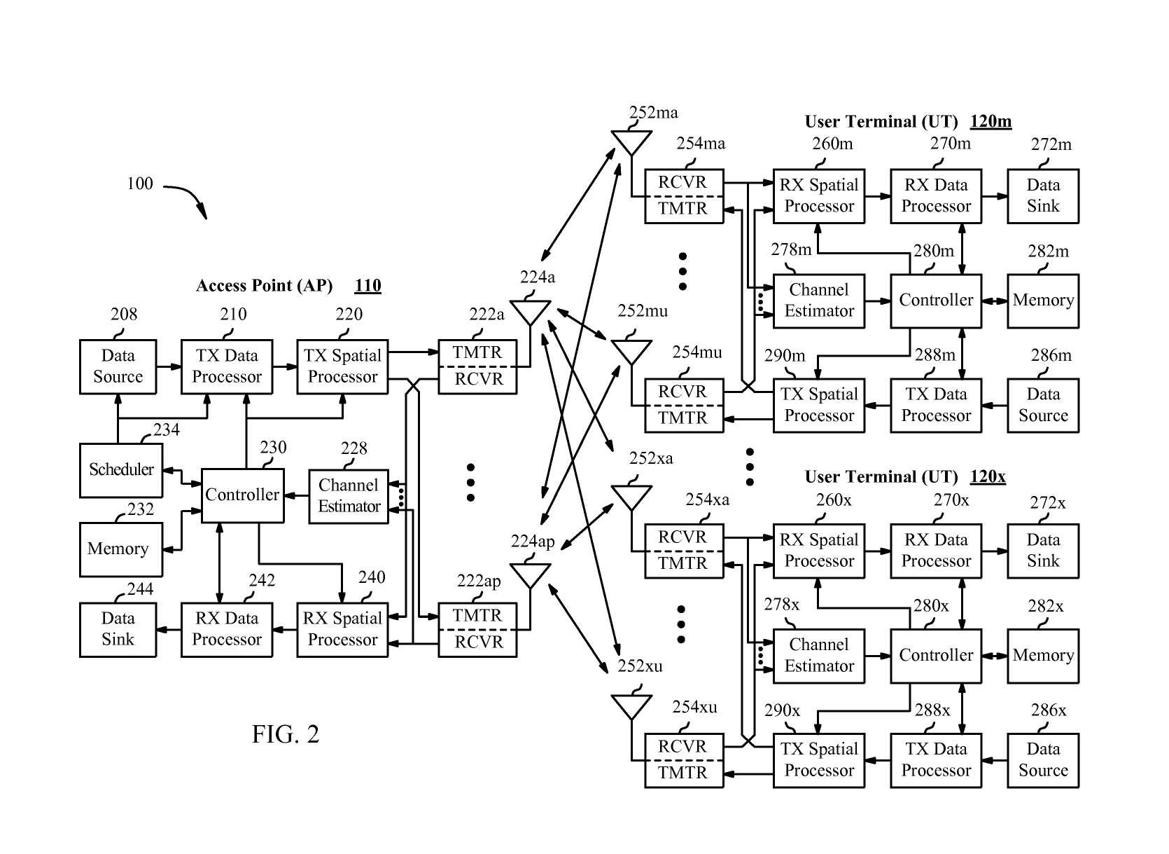

FIG. 2 illustrates a block diagram of access point 110 and two user terminals 120m and 120x in MIMO system 100. The access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device (e.g., an AP or STA) capable of transmitting data via a wireless channel, and a “receiving entity” is an independently operated apparatus or device (e.g., an AP or STA) capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point. Memory 282 may store data and program codes for the user terminal 120 and may interface with the controller 280.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. Memory 232 may store data and program codes for the access point 110 and may interface with the controller 230.

At each user terminal 120, N_{ut,m} ntennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

The controller 230 and/or the TX data processor 210 of the access point 110 (or the controller 280 and/or the TX data processor 288 of the user terminal 120) may generate a packet comprising a PSDU having control information conveyed in one or more tones of the PSDU that are not used for transmitting data or pilot signals, as described below. The controller 230 and/or the RX data processor 242 of the access point 110 (or the controller 280 and/or the RX data processor 270 of the user terminal 120) may process a received signal to generate a packet comprising a PSDU having control information conveyed in one or more tones of the PSDU that are not used for transmitting pilot signals or data, as described below.

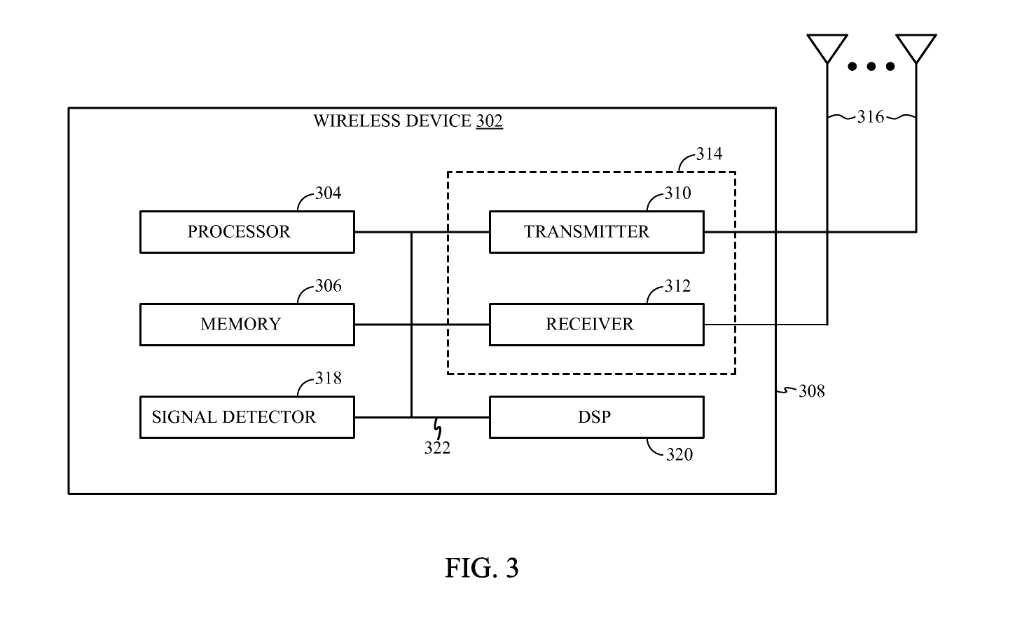

FIG. 3 illustrates various components that may be utilized in a wireless device 302 that may be employed within the MIMO system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

The processor 304 and/or the DSP 320 of the wireless device 302 may generate or obtain a packet comprising a PSDU having control information conveyed in one or more tones of the PSDU that are not used for transmitting traffic data or pilot signals, as described below.
Example Control Channel On PSDU Tones

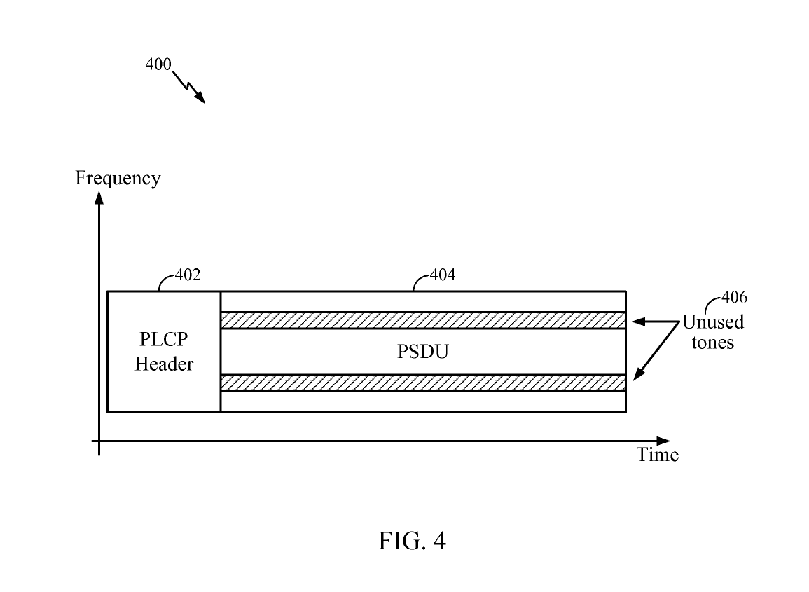

The IEEE 802.11ax physical layer (PHY) packet structure comprises N orthogonal frequency-division multiplexing (OFDM) tones that are not used for data transmission. FIG. 4 illustrates an example packet structure 400 having a physical layer convergence protocol (PLCP) header 402 and a PLCP service data unit (PSDU) 404. The PSDU 404 includes tones for conveying data, but may have other, unused tones 406. Additionally, certain tones (i.e., subcarriers) in a PSDU may be reserved for pilot signals rather than data (e.g., as defined in IEEE 802.11-2012) and, thus, would not qualify as unused tones in the PSDU. Equivalently, one can assume that in an orthogonal frequency-division multiple access (OFDMA) transmission (DL or UL), one or more of the frequency resources is devoted to the signaling described herein. Certain aspects of the present disclosure provide various options for utilizing these unused tones 406.
Encoding of the Signaling

Transmitting the control information on the unused tones may be accomplished in various ways. According to certain aspects, the signal sent in the control channel tones may be part of the OFDM waveform. This may avoid interference with the rest of the PSDU. For certain aspects, transmission of the control information may most likely be synchronized with the rest of the PPDU from the time domain perspective, which may involve either the same transmitter or different transmitters synchronized with one another. According to other aspects, the control signal may be generated and decoded independently from the OFDM waveform. This may implicate using very narrowband transmit (TX) and receive (RX) filters.

Reception typically entails synchronization and channel estimation (S-C), which may be accomplished in various ways. For example, the PPDU preamble may be used for synchronization and channel estimation. Additionally or alternatively, an additional “preamble” sent on the control tones themselves may be utilized. For certain aspects, there may be one preamble per control tones set (as described below with respect to FIG. 6).

According to certain aspects, the control information on the unused tones may be sent as broadcast information (e.g., can be received by any station (STA)), and may be sent without beamforming

Modulation for transmission on the tones with control information may be performed with any of various suitable schemes. For example, the control information may use the same modulation as the adjacent PSDU data in the same packet. Alternatively, a special modulation for the control information may be indicated in the PLCP header 402. This special modulation may be the same or different than adjacent PSDU data and may be tone-dependent. For other aspects, a fixed modulation may be defined by the standard (e.g. lowest modulation). This fixed modulation may be different for each unused tone or the same for all unused tones of a PSDU. For other aspects, on-off keying may be used for the unused tones, in which the presence of energy at certain tones and particular symbol times may be used for conveying control information.
Control Channel Structure

The meaning of the control information bits sent in the control channel tones may be defined: (1) relative to the tone position (e.g., with respect to frequency and/or time); or (2) as a structured field according to, for example, some “header” information sent along with the bits, which defines the meaning of the following bits.

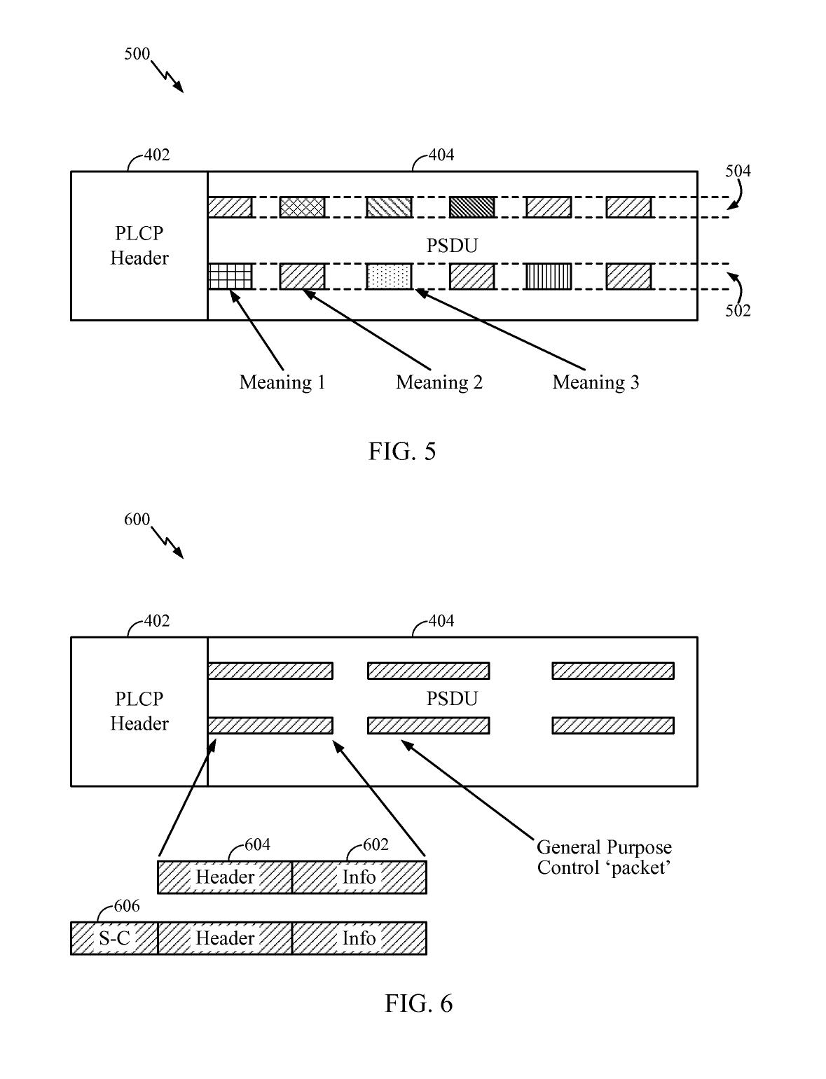

FIG. 5 illustrates an example packet structure 500 in which the tone position of the control information in the PSDU 404 conveys a particular meaning, in accordance with certain aspects of the present disclosure. For example, FIG. 5 illustrates a single tone 502 indicating at least three different meanings (labeled “Meaning 1,” “Meaning 2,” and “Meaning 3”), depending on the position (e.g., in time) within the PSDU 404. A second tone 504 in the PSDU 404 may indicate different meanings from the first tone, even if the time position is the same between the first and second tones. Although six different tone positions are illustrated for each tone 502, 504 in FIG. 5 as an example, the number of tone positions for control information may be higher or lower than six. Furthermore, different tones in the PSDU 404 may have a different number of available tone/ positions for control information. Although the various tone positions are illustrated in FIG. 5 as being aligned (e.g., have the same starting and stopping times) between the two different tones 502, 504, the tone positions need not be aligned between the two tones. For example, some tone positions may be aligned between the two tones 502, 504, whereas other tone positions may not be. Moreover, the various tone positions for conveying control information need not be the same length (within the same or different tones), although the tone positions depicted in the example packet structure 500 all have the same time length. For certain aspects, an indication of a single meaning may be conveyed using more than one tone position in a single tone, more than one tone, or a combination thereof

The definition of the meaning may be indicated, for example, by the IEEE standard or by the access point 110 through a management message (e.g., as a beacon, association response, and the like). A STA may use information in the standard or interpret a received management message to generate a packet (e.g., the packet structure 500) based on the meaning(s) of the control information the STA will convey. Upon reception of a packet, a STA may decode the PLCP header 402 in an effort to synchronize with the control tones and be able to decode these tones. The meaning may indicate that the control information is intended for or received from a certain STA, for example. As another example, the meaning may indicate certain control information, as described below.

For the case in which the meaning of the control information is defined as a structured field, FIG. 6 illustrates an example packet structure 600 in which the control information 602 in the PSDU has a header field 604 associated therewith, in accordance with certain aspects of the present disclosure. This type of structure (with the header field 604 preceding the control information 602) may be referred to as a general purpose control “packet.” For certain aspects, the header field 604 may include media access control (MAC) information. This may include the type, addresses, and/or structure of the control information 602. In this case, recipient STAs may detect the PLCP header 402 for synchronization and channel estimation. For other aspects, the control information header may additionally include a preamble for PHY synchronization and channel estimation (e.g., an S-C header 606). In this case, the STA need not decode the PLCP header 402; the STA may be able to synchronize through the dedicated S-C header 606 instead.
Control Information Bits

The following describes several examples of the information that may be carried in the bits of the PSDU control channels (the unused tones). These may be classified according to: (1) information sent by the same PPDU transmitter; and (2) information sent by transmitters other than the PPDU sender. Type 1 may be further divided into: (A) information intended for the same receiver as the PPDU data; and (B) information for destinations other than the data receiver (in DL PPDU). Type 2 may be further divided into: (A) piggybacking information in UL; and (B) using the tones for a (continuation of the) backoff procedure.

### Type 1: Control Information Sent By Same PPDU Transmitter

In cases where the control information is intended for the same receiver as the PPDU data, this information may include control information that can be used for the decoding of the remaining portion of the PPDUs, for certain aspects. For example, this control information may include the modulation and coding scheme (MCS) of the following OFDM symbol (e.g., for MPDU delimiter (MD) aggregated MPDU (A-MPDU)). Another example includes control information that is not necessary for the packet decoding, but can be used by the receiver as soon as the packet ends (e.g., an indication of the presence and/or duration of an immediate response). Yet another example includes control information that could be sent at the MAC layer, but would cause large overhead. Using the PHY control channel according to certain aspects of the present disclosure provides for reduced overhead. Such information may include most of the information in quality of service (QoS) control, high throughput control (HTC), and some of the information currently designated for the PLCP header 402; feedback of buffer status/more data (e.g., to tell the other party how much data the sender has in the buffer that will be sent or to indicate “more data,” which signifies more data transmission will follow); power saving transitions (e.g., whether transmitter is going to sleep); and/or the transmit (TX) power level.

In cases (e.g., DL PPDU) where the control information is intended for destinations other than the receiver of the data, the unused tones may carry broadcast information for certain aspects. Such broadcast information may include UL allocation information for UL management frames such as probe request, association request, etc.; medium-reuse criteria, such as transmit power and signal-to-interference-plus-noise ratio (SINR) specifications for this transmission; basic service set identifier (BSSID) and updated network allocation vector (NAV) information; and clear channel assessment (CCA) used to access (if per-STA CCA is implemented). As another example, the unused tones may carry control information for specific STAs. In this case, specific tones/symbols may be assigned to certain STAs, and the tone information may contain the STAs' identifiers. As yet another example, the control information may include scheduling information for multiple STAs (e.g., UL MU-MIMO trigger information) or selected information from the beacon (e.g., beacon sequence number, least significant bits (LSBs) of timing synchronization function (TSF), next target beacon transmission time (TBTT), and the like). If the PPDU is a UL PPDU, the unused tones may carry medium-reuse criteria, such as transmit power and SINR specifications for this transmission; BSSID and updated NAV information; and/or CCA used to access (if per-STA CCA is implemented).

### Type 2: Control Information Sent By Transmitters Other Than the PPDU Sender

STAs detecting the PPDU preamble can transmit on certain tones. STAs can access the tones with random contention. Tones can be assigned to STAs a priori, for dedicated signaling. Tones can also be used for CDMA-like multiplexing.

As outlined above, control information may be piggybacked on a PSDU sent by another transmitter in UL. In other words, while a PPDU is being transmitted in UL, other STAs can send control information on the leftover tones (the tones not being used for pilot signal or data transmission). For example, this information may include a buffer status/UL transmission request, a power-save (PS) transition, a PS-Poll request, or a probe request (in which case the access point 110 may respond with a fast initial link setup (FILS) beacon).

As delineated above, the unused tones may be used for a backoff procedure (or a continuation thereof) by a transmitter other than the sender of a PPDU (e.g., according to the packet structure 400). In other words, while a PPDU is being transmitted by one STA, another STA may continue/start a contention procedure on (some of) the leftover tones. STAs decode these tone(s) and detect the presence of signal (e.g., CCA). While tones are idle, a STA counts down its backoff. Once backoff expires, the STA sends on the tones. Once PPDU is over, the winner of the contention can transmit without further backoff. This can speed up contention-based access.

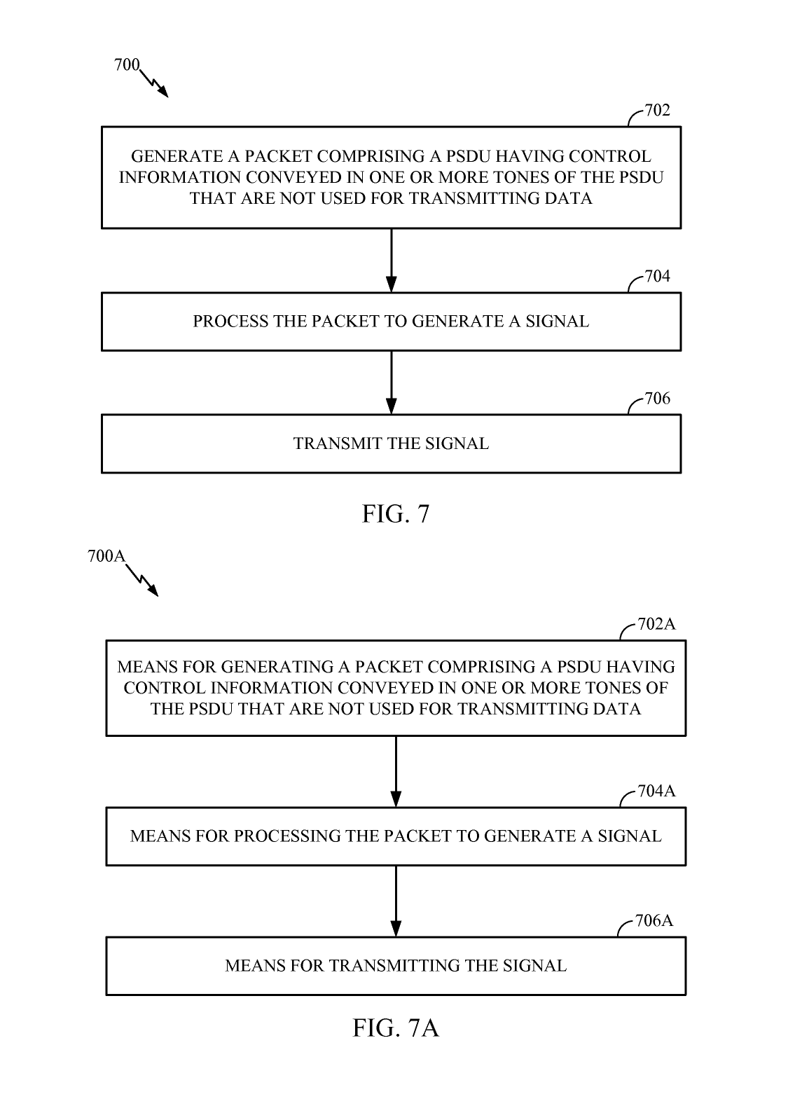

FIG. 7 is a flow diagram of example operations 700 for transmitting a packet including a PSDU having control information conveyed on unused tones, in accordance with certain aspects of the present disclosure. The operations 700 may be performed, for example, by an apparatus (e.g., access point 110 or user terminal 120). The operations 700 may begin, at block 702, with the apparatus generating a packet comprising a PSDU having control information conveyed in one or more tones of the PSDU that are not used for transmitting data (or pilot signals). At block 704, the apparatus processes the packet to generate a signal (e.g., for wireless communications). The apparatus transmits the (wireless) signal at block 706.

According to certain aspects, the control information conveyed is part of an OFDM waveform for the PSDU.

According to certain aspects, transmitting the signal at block 706 involves transmitting the one or more tones conveying the control information via the same transmitter that transmits other tones of the PSDU used for transmitting data.

According to certain aspects, transmitting the signal at block 706 entails transmitting, from a first apparatus, the one or more tones conveying the control information; and transmitting, from a second apparatus different from the first apparatus, other tones of the PSDU used for transmitting data. In this case, transmitting the one or more tones conveying the control information from the first apparatus may include starting or continuing a contention procedure using the one or more tones conveying the control information.

According to certain aspects, generating the packet at block 702 involves generating the control information differently than an OFDM waveform for the PSDU.

According to certain aspects, processing the packet at block 704 includes applying a first modulation and coding scheme (MCS) to the control information and applying a second MCS to other tones of the PSDU used for transmitting data. For certain aspects, the first and second MCSs are the same, whereas in other aspects, the second MCS is different from the first MCS. The packet may further include a PLCP header. For certain aspects, the first MCS is indicated by the PLCP header.

According to certain aspects, generating the packet at block 702 involves positioning at least a portion of the control information in at least one of frequency or time within the PSDU to indicate a particular meaning of the at least the portion of the control information. The particular meaning may include at least one of a source or a destination of the control information. For certain aspects, the operations 700 further include the apparatus transmitting a message indicating the particular meaning.

According to certain aspects, generating the packet at block 702 entails adding, in the one or more tones, a header field for at least a portion of the control information to indicate a particular meaning of the at least the portion of the control information. For certain aspects, the header field includes one or more features for at least one of synchronization or channel estimation.

According to certain aspects, at least a portion of the control information has a different intended recipient than data in the PSDU. In this case, the at least the portion of the control information may include broadcast information.

According to certain aspects, the one or more tones include one or more subchannels for OFDMA transmission.

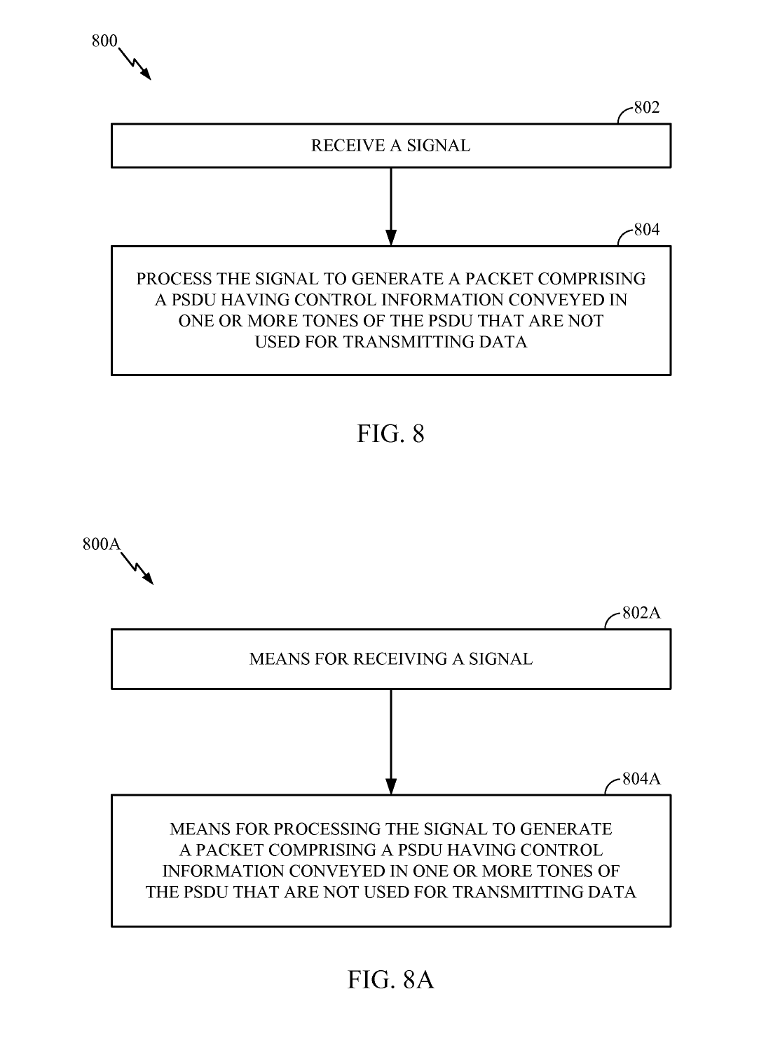

FIG. 8 is a flow diagram of example operations 800 for receiving a packet including a PSDU having control information conveyed on unused tones, in accordance with certain aspects of the present disclosure. The operations 800 may be performed, for example, by an apparatus (e.g., access point 110 or user terminal 120). The operations 800 may begin, at block 802, with the apparatus receiving a (wireless) signal. At block 804, the apparatus processes the signal to generate a packet comprising a PSDU having control information conveyed in one or more tones of the PSDU that are not used for transmitting data (or pilot signals).

According to certain aspects, the operations 800 may further involve the apparatus performing at least one of synchronization or channel estimation based on the one or more tones conveying the control information.

According to certain aspects, the control information conveyed is part of an OFDM waveform for the PSDU.

According to certain aspects, receiving the signal at block 802 includes receiving, from a first apparatus, the one or more tones conveying the control information and receiving, from a second apparatus different from the first apparatus, other tones of the PSDU used for transmitting data.

According to certain aspects, the operations 800 further entail demodulating and decoding the control information using a first MCS and demodulating and decoding, using a second MCS, other tones of the PSDU used for transmitting data. For certain aspects, the second MCS is different from the first MCS, while for other aspects, the first and second MCS are the same. The packet may further include a PLCP header. In this case, the first MCS may be indicated by the PLCP header.

According to certain aspects, the operations 800 further involve the apparatus interpreting a meaning of at least a portion of the control information based on a position of the at least the portion of the control information in at least one of frequency or time within the PSDU. For certain aspects, the operations 800 further include the apparatus receiving a message indicating the meaning before the interpreting. The meaning may include at least one of a source or a destination of the control information, for example.

According to certain aspects, the operations 800 further entail the apparatus interpreting a meaning of at least a portion of the control information based on a header field, in the one or more tones, for the at least the portion of the control information. In this case, the operations 800 may further involve the apparatus performing at least one of synchronization or channel estimation for at least one of the one or more tones, based on the header field for the at least the portion of the control information.

According to certain aspects, the operations 800 further include the apparatus ignoring at least a portion of the control information having a different intended recipient than data in the PSDU.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 700 and 800 illustrated in FIGS. 7 and 8 correspond to means 700A and 800A illustrated in FIGS. 7A and 8A, respectively.

For example, means for transmitting may comprise a transmitter (e.g., the transmitter unit 222) and/or the antenna(s) 224 of the access point 110 illustrated in FIG. 2, a transmitter (e.g., the transmitter unit 254) and/or the antenna(s) 252 of the user terminal 120 portrayed in FIG. 2, or the transmitter 310 and/or antenna(s) 316 depicted in FIG. 3. Means for receiving may comprise a receiver (e.g., the receiver unit 222) and/or the antenna(s) 224 of the access point 110 illustrated in FIG. 2, a receiver (e.g., the receiver unit 254) and/or the antenna(s) 252 of the user terminal 120 shown in FIG. 2, or the receiver 312 and/or antenna(s) 316 depicted in FIG. 3. Means for processing, means for generating, and/or means for determining may comprise a processing system, which may include one or more processors (e.g., capable of implementing the algorithm or operations 700, 800), such as the RX data processor 242, the TX data processor 210, and/or the controller 230 of the access point 110 illustrated in FIG. 2, the RX data processor 270, the TX data processor 288, and/or the controller 280 of the user terminal 120 illustrated in FIG. 2 or the processor 304 and/or the DSP 320 portrayed in FIG. 3.

In some cases, rather than actually transmitting a packet (or frame), a device may have an interface to output a packet for transmission. For example, a processor may output a packet, via a bus interface, to an RF front end for transmission. Similarly, rather than actually receiving a packet (or frame), a device may have an interface to obtain a packet received from another device. For example, a processor may obtain (or receive) a packet, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications, comprising:
generating a packet comprising a physical layer convergence protocol (PLCP) service data unit (PSDU) having control information conveyed in one or more tones of the PSDU that are not used for transmitting data;
processing the packet to generate a signal; and
transmitting the signal.

2. The method of claim 1, wherein the control information conveyed is part of an orthogonal frequency-division multiplexing (OFDM) waveform for the PSDU.

3. The method of claim 1, wherein transmitting the signal comprises transmitting the one or more tones conveying the control information via the same transmitter that transmits other tones of the PSDU used for transmitting data.

4. The method of claim 1, wherein transmitting the signal comprises:
transmitting, from a first apparatus, the one or more tones conveying the control information; and
transmitting, from a second apparatus different from the first apparatus, other tones of the PSDU used for transmitting data, wherein transmitting the one or more tones conveying the control information from the first apparatus comprises starting or continuing a contention procedure using the one or more tones conveying the control information.

5. The method of claim 1, wherein generating the packet comprises generating the control information differently than an orthogonal frequency-division multiplexing (OFDM) waveform for the PSDU.

6. The method of claim 1, wherein processing the packet comprises:
applying a first modulation and coding scheme (MCS) to the control information; and
applying a second MCS to other tones of the PSDU used for transmitting data, wherein the packet further comprises a PLCP header and wherein the first MCS is indicated by the PLCP header.

7. The method of claim 1, wherein generating the packet comprises positioning at least a portion of the control information in at least one of frequency or time within the PSDU to indicate a particular meaning of the at least the portion of the control information.

8. The method of claim 7, further comprising transmitting a message indicating the particular meaning.

9. The method of claim 1, wherein:
generating the packet comprises adding, in the one or more tones, a header field for at least a portion of the control information to indicate a particular meaning of the at least the portion of the control information; and
the header field comprises one or more features for at least one of synchronization or channel estimation.

10. The method of claim 1, wherein:
at least a portion of the control information has a different intended recipient than data in the PSDU; and
the at least the portion of the control information is broadcast information.

11. The method of claim 1, wherein the one or more tones comprise one or more subchannels for orthogonal frequency-division multiple access (OFDMA) transmission.

12. A method for wireless communications, comprising:
receiving a signal; and
processing the signal to generate a packet comprising a physical layer convergence protocol (PLCP) service data unit (PSDU) having control information conveyed in one or more tones of the PSDU that are not used for transmitting data.

13. The method of claim 12, further comprising performing at least one of synchronization or channel estimation based on the one or more tones conveying the control information.

14. The method of claim 12, wherein the control information conveyed is part of an orthogonal frequency-division multiplexing (OFDM) waveform for the PSDU.

15. The method of claim 12, wherein receiving the signal comprises:
receiving, from a first apparatus, the one or more tones conveying the control information; and
receiving, from a second apparatus different from the first apparatus, other tones of the PSDU used for transmitting data.

16. The method of claim 12, further comprising:
demodulating and decoding the control information using a first modulation and coding scheme (MCS); and
demodulating and decoding, using a second MCS, other tones of the PSDU used for transmitting data, wherein the packet further comprises a PLCP header and wherein the first MCS is indicated by the PLCP header.

17. The method of claim 12, further comprising:
interpreting a meaning of at least a portion of the control information based on a position of the at least the portion of the control information in at least one of frequency or time within the PSDU; and
receiving a message indicating the meaning before the interpreting.

18. The method of claim 17, wherein the meaning comprises at least one of a source or a destination of the control information.

19. The method of claim 12, further comprising:
interpreting a meaning of at least a portion of the control information based on a header field, in the one or more tones, for the at least the portion of the control information; and
performing at least one of synchronization or channel estimation for at least one of the one or more tones, based on the header field for the at least the portion of the control information.

20. The method of claim 12, further comprising ignoring at least a portion of the control information having a different intended recipient than data in the PSDU.

21. An apparatus for wireless communications, comprising:
a processing system configured to:
generate a packet comprising a PSDU having control information conveyed in one or more tones of the PSDU that are not used for transmitting data; and
process the packet to generate a signal; and
a transmitter coupled to the processing system and configured to transmit the signal.

22. The apparatus of claim 21, wherein the processing system is configured to process the packet by:
applying a first modulation and coding scheme (MCS) to the control information; and
applying a second MCS to other tones of the PSDU used for transmitting data, wherein the first MCS is different from the second MCS, wherein the packet further comprises a PLCP header, and wherein the first MCS is indicated by the PLCP header.

23. The apparatus of claim 21, wherein the processing system is configured to generate the packet by positioning at least a portion of the control information in at least one of frequency or time within the PSDU to indicate a particular meaning of the at least the portion of the control information.

24. The apparatus of claim 23, wherein the transmitter is further configured to transmit a message indicating the particular meaning.

25. The apparatus of claim 21, wherein:
the processing system is configured to generate the packet by adding, in the one or more tones, a header field for at least a portion of the control information to indicate a particular meaning of the at least the portion of the control information; and
the header field comprises one or more features for at least one of synchronization or channel estimation.

26. A first apparatus for wireless communications, comprising:
a receiver configured to receive a signal; and
a processing system coupled to the receiver and configured to process the signal to generate a packet comprising a physical layer convergence protocol (PLCP) service data unit (PSDU) having control information conveyed in one or more tones of the PSDU that are not used for transmitting data.

27. The first apparatus of claim 26, wherein the processing system is further configured to perform at least one of synchronization or channel estimation based on the one or more tones conveying the control information.

28. The first apparatus of claim 26, wherein the receiver is configured to receive the signal by:
receiving, from a second apparatus, the one or more tones conveying the control information; and
receiving, from a third apparatus different from the second apparatus, other tones of the PSDU used for transmitting data.

29. The first apparatus of claim 26, wherein the processing system is further configured to:
demodulate and decode the control information using a first modulation and coding scheme (MCS); and
demodulate and decode, using a second MCS, other tones of the PSDU used for transmitting data, wherein the packet further comprises a PLCP header and wherein the first MCS is indicated by the PLCP header.

30. The first apparatus of claim 26, wherein:
the processing system is further configured to interpret a meaning of at least a portion of the control information based on a position of the at least the portion of the control information in at least one of frequency or time within the PSDU; and
the receiver is further configured to receive a message indicating the meaning before the interpretation by the processing system.
